(19) United States
(12) Patent Application Publication
(10) Pub. No.: US 2026/0087176 A1
(43) Pub. Date: Mar. 26, 2026

(54) ELECTRONIC DEVICE, CONTROL METHOD OF ELECTRONIC DEVICE, AND STORAGE MEDIUM

(71) Applicant: CANON KABUSHIKI KAISHA, Tokyo (JP)

(72) Inventor: RURIKO MIKAMI, Kanagawa (JP)

(21) Appl. No.: 19/333,660

(22) Filed: Sep. 19, 2025

(30) Foreign Application Priority Data
Sep. 24, 2024 (JP) 2024-165397

(51) Int. Cl. G06F 21/62; G06F 21/31

(52) U.S. Cl. CPC G06F 21/629; G06F 21/31

(57) ABSTRACT

An electronic device includes: an obtainment unit that obtains information indicating an agreement state of a user about a permission content; and a control unit that performs control to execute predetermined processing by application software without displaying an acceptance screen to accept an operation indicating agreement from the user in a case of a first state, in which the user agrees with all the one or more permission contents that include a first permission content and that need to obtain agreement of the user to utilize the application software in a case where first launching of the application software is instructed, and performs control to display the acceptance screen before executing the predetermined processing in a case of a second state, in which the agreement state about the first permission content corresponds to disagreement of the user in a case where the first launching of the application software is instructed.

### BACKGROUND

### Field of the Technology

The present disclosure relates to an electronic device, a control method of the electronic device, and a storage medium.

### Description of the Related Art

A system that displays a necessary permission acceptance screen in a case where application software (hereinafter, an application) is added to an electronic device and provides a service of the application added to the electronic device if an agreement of a user is obtained has been known.

Japanese Patent Laid-Open No. 2021-124775 discloses a system in a case where an application is added to an information processing apparatus, which does not display a permission acceptance screen in a case where an agreement on a target permission is not obtained, and which displays the permission acceptance screen in a case where there is a difference in the permission contents. Thus, in a case where it is unnecessary to obtain the permission, it is possible to reduce an operation of the permission by the user.

On the other hand, in Japanese Patent Laid-Open No. 2021-124775, in some cases, a newly added other application cannot be utilized due to the obtainment of a disagreement on the permission that is necessary to utilize an already-existing application.

### SUMMARY

Therefore, an object of the present disclosure is to execute preferable processing to utilize application software depending on an agreement state in a case where the application software is added.

An electronic device according to an aspect of the present disclosure includes: an obtainment unit that obtains information indicating an agreement state of a user about a permission content; and a control unit that performs control to execute predetermined processing by application software without displaying an acceptance screen to accept an operation indicating agreement from the user in a case of a first state, in which the user agrees with all the one or more permission contents that include a first permission content and that need to obtain agreement of the user to utilize the application software in a case where first launching of the application software is instructed, and performs control to display the acceptance screen before executing the predetermined processing in a case of a second state, in which the agreement state about the first permission content corresponds to disagreement of the user in a case where the first launching of the application software is instructed.

Features of the present disclosure will become apparent from the following description of embodiments with reference to the attached drawings. The following description of embodiments are described by way of example.

### BRIEF DESCRIPTION OF THE DRAWINGS

FIG. 1 is a configuration diagram of a system.

FIGS. 2A and 2B are block diagrams of an electronic device.

FIG. 3 is a diagram illustrating management information of an application group included in an image processing apparatus.

FIG. 4 is a diagram illustrating a permission type and an agreement state of the image processing apparatus.

FIG. 5 is a screen flow diagram illustrating agreement acceptance processing on a permission of the image processing apparatus.

FIG. 6 is a flowchart illustrating adding processing of an application of the image processing apparatus.

FIG. 7 is a flowchart illustrating processing of launching the application of the image processing apparatus.

FIG. 8 is a flowchart illustrating processing of launching an application of a mobile terminal.

### DESCRIPTION OF THE EMBODIMENTS

Embodiments of the present disclosure are described below with reference to the drawings. Note that, relative arrangement, apparatus shapes, and the like of constituents of the apparatus used in the embodiment are merely examples, and it is not limited only thereto. In addition, in the appended drawings, the same or similar configurations are provided with the same reference numerals, and duplicated descriptions are omitted.

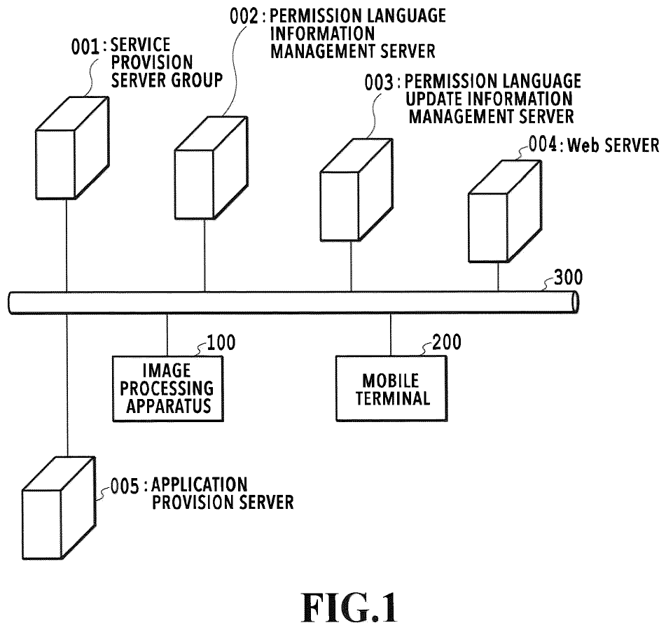

FIG. 1 is a configuration diagram illustrating an overall configuration of a system according to the present embodiment. An information processing system of the present embodiment includes a service provision server group 001, a permission language information management server 002, a permission language update information management server 003, a WEB server 004, an application provision server 005, an image processing apparatus 100, and a mobile terminal 200. The constituents are communicably connected to each other via a communication network 300.

The service provision server group 001 is a server that provides a service of the image processing apparatus 100 cooperating with a cloud server system (a server system on the Internet). The cloud server system provides a service such as printing image data on a cloud (on the Internet) by the image processing apparatus 100, saving the image data scanned by the image processing apparatus 100 on the cloud, and the like.

The permission language information management server 002 manages the latest permission version of a permission language. In a case where there is a change in the permission language to be agreed by a user due to an additional function, law revision, or the like, the latest permission version is updated.

The permission language update information management server 003 manages transmittable permission versions as the permission versions necessary to transmit information by classifying the transmittable permission versions according to country. Additionally, the permission language update information management server 003 determines a country in which the image processing apparatus 100 is installed and returns the transmittable permission version of the permission according to the country. In a case where there is a change in the permission language that needs to be agreed by the user due to an additional function, law revision, or the like, transmittable permission version information in the server is updated.

The WEB server 004 stores the latest permission language of each area. The application provision server 005 is a server that provides application software (hereinafter, referred to as an application) that is installed in the image processing apparatus 100 to be utilized. The application is configured to provide the service in cooperation with the service provision server group 001. For example, there is an application that transmits the image data scanned by the image processing apparatus 100 to the service provision server group 001 cooperating with the cloud server system.

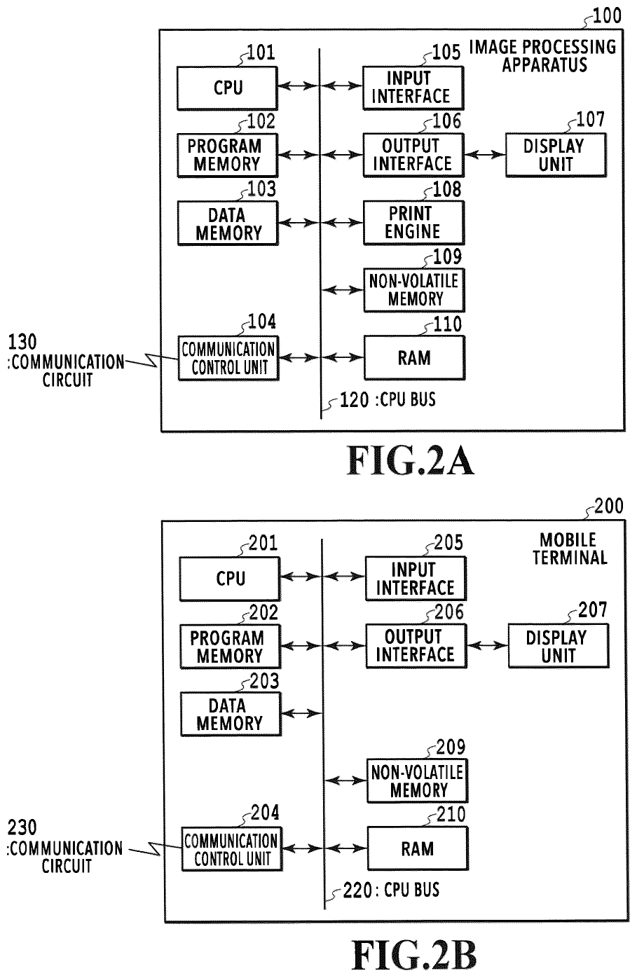

FIGS. 2A and 2B are block diagrams of an electronic device. FIG. 2A is a diagram illustrating a configuration of the image processing apparatus 100 in the present embodiment. The image processing apparatus 100 is an electronic device. The image processing apparatus 100 includes a CPU 101, a program memory 102, a data memory 103, a communication control unit 104, an input interface 105, an output interface 106, a display unit 107, a print engine 108, a non-volatile memory 109, and a RAM 110.

The CPU 101 is a system control unit that controls overall the image processing apparatus 100. The program memory 102 stores a control program executed by the CPU 101, an embedded operating system program, and the like. The data memory 103 stores a program control variable and the like and is provided with various working buffer regions utilized during processing of the print engine 108.

The communication control unit 104 controls data transmission and reception to and from the outside via a communication circuit 130. The input interface 105 is an interface that accepts data input and an operation instruction from the user and is formed of a physical keyboard, a button, a touch panel, and the like. Note that, the later-described output interface 106 and the input interface 105 may have the same configuration, and a mode in which output of a screen and acceptance of an operation from the user are performed by the same configuration may be applied. The output interface 106 is an interface that controls the display unit 107 to display the data and notify of a state of the image processing apparatus 100.

The display unit 107 is formed of a light-emitting diode (LED), a liquid crystal display (LCD), and the like and displays the data and notifies of the state of the image processing apparatus 100. Note that, a software keyboard including a key such as a numerical value input key, a mode setting key, a determination key, a cancel key, and a power key may be installed on the display unit 107 to accept the input from the user via the display unit 107. The print engine 108 forms an image on a printing medium such as paper using a printing material such as an ink based on information saved in the data memory 103 and a received print job and outputs a print result.

The non-volatile memory 109 is formed of a device such as an electrically erasable programmable read-only memory (EEPROM) and a flash memory. The non-volatile memory 109 is mainly used for purpose of saving data such as a setting value of the image processing apparatus 100, which needs to be held also in a case where the image processing apparatus 100 is not supplied with power. Hereinafter, the non-volatile memory 109 is also referred to as a storage unit. The RAM 110 is formed of a dynamic random access memory (DRAM) and the like that need backup power supply. The RAM 110 is also used as a main memory and a working memory of the CPU 101 and saves a reception buffer that temporarily saves print information received from a PC and the like and various types of information. The above-described constituents 101 to 106 and 108 to 110 are connected to each other via a CPU bus 120 managed by the CPU 101.

The image processing apparatus 100 is communicable with the servers indicated by 001 to 005 and the mobile terminal 200 via the communication network 300. The image processing apparatus 100 communicates with the servers indicated by 001 to 005 to obtain the permission language, the permission version associated with the permission language, and the like and hold the obtained information in the non-volatile memory 109.

FIG. 2B is a diagram illustrating a configuration of the mobile terminal 200 that is one of electronic devices in the present embodiment. The mobile terminal 200 includes a CPU 201, a program memory 202, a data memory 203, a communication control unit 204, an input interface 205, an output interface 206, a display unit 207, a non-volatile memory 209, and a RAM 210.

The CPU 201 is a system control unit that controls overall the mobile terminal 200. The program memory 202 stores a control program executed by the CPU 201, an embedded operating system program, and the like. The data memory 203 stores a program control variable and the like and is provided with various working buffer regions.

The communication control unit 204 controls data transmission and reception to and from the outside via a communication circuit 230. The input interface 205 is an interface that accepts data input and an operation instruction from the user and is formed of a physical keyboard, a button, a touch panel, and the like. Note that, the later-described output interface 206 and the input interface 205 may have the same configuration, and a mode in which output of a screen and acceptance of an operation from the user are performed by the same configuration may be applied. The output interface 206 is an interface that controls the display unit 207 to display the data and notify of a state of the mobile terminal 200.

The display unit 207 is formed of a light-emitting diode (LED), a liquid crystal display (LCD), and the like and displays the data and notifies of the state of the mobile terminal 200. Note that, a software keyboard including a key such as a numerical value input key, a mode setting key, a determination key, a cancel key, and a power key may be installed on the display unit 207 to accept the input from the user via the display unit 207. The non-volatile memory 209 is formed of a device such as an electrically erasable programmable read-only memory (EEPROM) and a flash memory. The non-volatile memory 209 is mainly used for purpose of saving data such as a setting value of the mobile terminal 200, which needs to be held also in a case where the mobile terminal 200 is not supplied with power.

The RAM 210 is formed of a dynamic random access memory (DRAM) and the like that need backup power supply. The RAM 210 is also used as a main memory and a working memory of the CPU 201 and saves a transmission buffer that temporarily saves information to be transmitted to the mobile terminal 200 and various types of information. The above-described constituents 201 to 206 and 209 and 210 are connected to each other via a CPU bus 220 managed by the CPU 201.

The mobile terminal 200 is communicable with the servers indicated by 001 to 004 and the image processing apparatus 100 via the communication network 300. The mobile terminal 200 communicates with the servers indicated by 001 to 004 to obtain the permission language, the permission version associated with the permission language, and the like and hold the obtained information in the non-volatile memory 209.

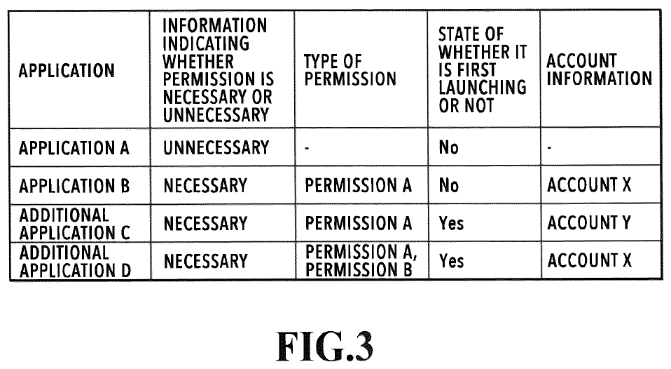

FIG. 3 is a diagram illustrating management information of an application group included in the image processing apparatus 100 in the present embodiment. The image processing apparatus 100 includes applications A and B, which are pre-installed in advance before shipment. Additionally, the image processing apparatus 100 includes additional applications C and D, which are installed by the user after shipment.

The management information illustrated in FIG. 3 holds “information indicating whether permission is necessary or unnecessary,” “type of permission,” “state of whether it is first launching or not,” and “account information” for each application name.

“Information indicating whether permission is necessary or unnecessary” is information indicating whether it is necessary or unnecessary to obtain the permission in a case where the user utilizes the application. “Type of permission” indicates a type of permission that is necessary in a case where the user utilizes the application. For example, the application D indicates that it is necessary to agree with both the permission A and permission B to utilize the application D. The permissions are associated with the permission language and the latest permission version managed by the permission language information management server 002.

There are two states, “yes” and “no,” as “state of whether it is first launching or not.” “Yes” is an initial value that is set to the CPU 101 in a case where the application is installed. Additionally, the state is changed to “no” in the first launching of the application.

“Account information” indicates an account necessary to use the application. For example, it is indicated that it is necessary to log in an account X to utilize the application B. Note that, it is indicated that an application with no description of the account information like the application A does not need to log in a specific account. Note that, the management information illustrated in FIG. 3 is held in the non-volatile memory 109.

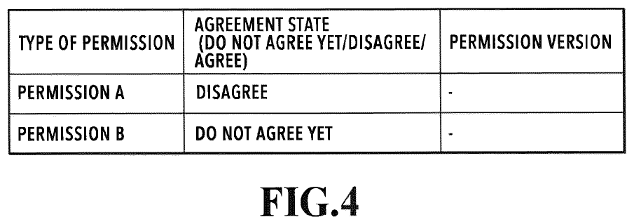

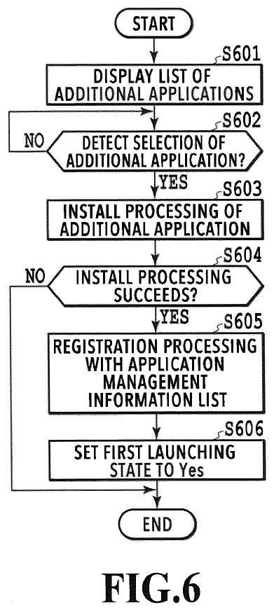

FIG. 4 is a diagram illustrating a storing state of an agreement state for each type of permission of the image processing apparatus 100 in the present embodiment. The storing state is controlled by the CPU 101 and held in the non-volatile memory 109. The CPU 101 stores the agreement state related to the permission A or the permission B as the type of permission. The non-volatile memory 109 holds the agreement state and the permission version (a version of the permission language as a target of the agreement state) for each type of permission. The agreement state stores a value corresponding to any one of three states, which are do not agree yet (do not permit yet), disagree (do not permit), and agree (permit). For example, in FIG. 6, the agreement state (a permission state) in the permission B is “agree.”

“Agree” is a state in which an operation indicating that the user agrees with the permission language managed by the permission language information management server 002 is accepted, and the permission version of the permission language in a case where the agreement operation is accepted (in a case where the agrees) is stored in association. “Disagree” is a state in which an operation indicating that the user disagrees with the permission language managed by the permission language information management server 002 is accepted.

“Do not agree yet” is a state in which the user neither agrees nor disagrees with the permission language. Do not agree yet is an initial value that is a value set in a case where the image processing apparatus 100 is shipped out from a factory.

Note that, in addition to the three states, a value indicating a state of “need agreement again” may be stored. Need agreement again (need permission again) is a state in which it is necessary to confirm again the intention of agreement of the user because there is a change in the permission language that needs to be agreed by the user due to law revision or the like. The CPU 101 communicates with the permission language update information management server 003 on a regular basis and obtains the transmittable permission version for each permission type. Then, in a case where the transmittable permission version is greater than the permission version illustrated in FIG. 4, “need agreement again” is set as the agreement state.

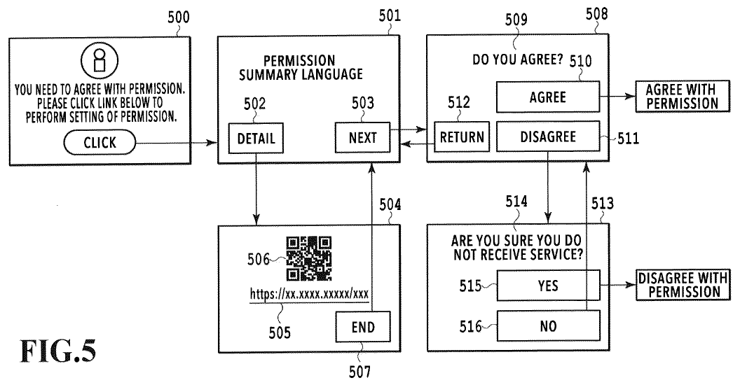

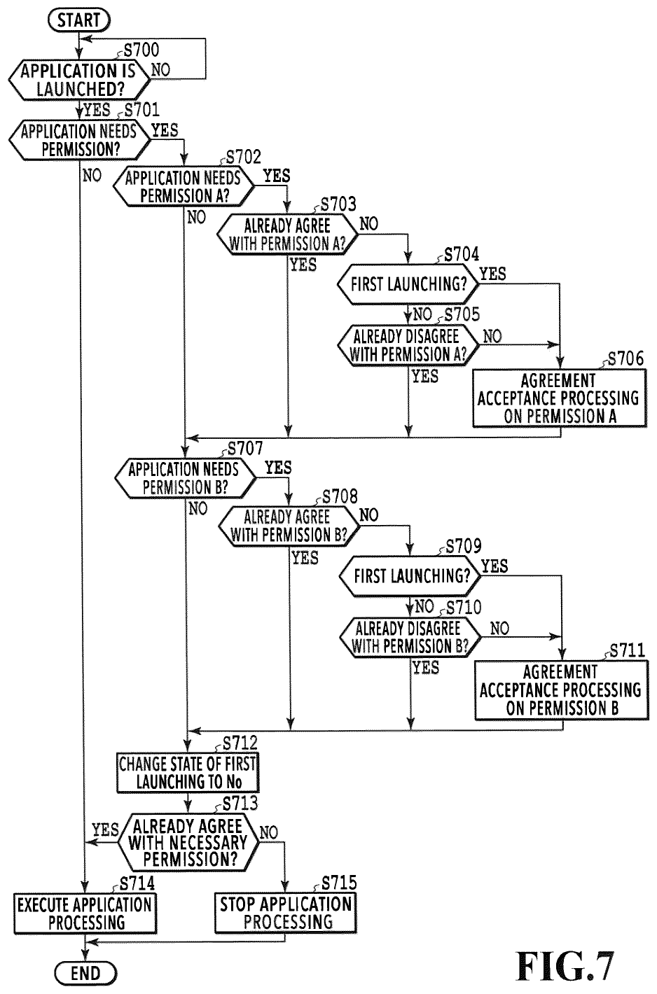

FIG. 5 is a diagram illustrating a screen transition in agreement acceptance processing on the permission of the image processing apparatus 100 in the present embodiment. Displaying of a screen that shows the agreement acceptance processing is controlled by the CPU 101. Each processing in the screen transition diagram illustrated in FIG. 5 is implemented with the CPU 101 deploying a program of the application stored in the program memory 102 in the RAM 110 to execute. That is, displaying of the screen that shows the agreement acceptance processing is controlled by the CPU 101. Note that, in the present embodiment, the screen transition described in FIG. 5 is executed in agreement acceptance processing on the permission A (S706) and agreement acceptance processing on the permission B (S711) in FIG. 7 described later.

A screen 500 is an information screen to notify the user of that the permission is necessary. The CPU 101 reads out the information screen from the RAM 110 and displays the information screen on the display unit 107. Once pressing of a click button is detected via the input interface 105, the screen transitions to a screen 501. Note that, a URL of a screen provided by the pre-installed application that is, for example, an embedded WEB browser is embedded in the click button. Additionally, a language displayed on the information screen in a case where the additional application is launched for the first time (YES in S704 and S709 described later) may be a language different from normal like “Because this is the first launching, agreement with the permission is confirmed again.” That is, the language displayed on the information screen may be changed depending on whether the corresponding application is launched for the first time.

The screen 501 is a screen to display a permission summary language. The CPU 101 reads out the summary language of the permission on which the agreement acceptance processing is currently performed from the non-volatile memory 109 and displays the language on the display unit 107. Once pressing (touching) of a “detail” button 502 is detected via the input interface 105, the CPU 101 displays a screen 504. Once pressing of a “next” button 503 is detected, the CPU 101 displays a screen 508.

The screen 504 is a screen to display a URL to access a detailed permission language. The CPU 101 obtains a URL to access the WEB server 004 from the permission language information management server 002 via the communication control unit 104. Then, a character string 505 of the URL and a two-dimensional code 506 including information of the URL are displayed on the display unit 107. Once pressing of an “end” button 507 is detected via the input interface 105, the CPU 101 displays the screen 501.

The screen 508 is a screen to accept the agreement (an agreement acceptance screen). The CPU 101 reads out a language 509 of “Do you agree?” from the non-volatile memory 109 and displays the language on the display unit 107. Once pressing of an “agree” button 510 is detected via the input interface 105, the CPU 101 stores information indicating agree as the agreement state of the permission language (the type of permission) as the target of the current agreement acceptance processing.

Once pressing of “disagree” button 511 is detected on the screen 508 via the input interface 105, the CPU 101 displays a screen 513. Additionally, once pressing of a “return” button 512 is detected, the screen 501 is displayed.

The screen 513 is a confirmation screen of disagreement. The CPU 101 reads out a language 514 indicating that the service cannot be provided due to the disagreement from the non-volatile memory 109 and displays the language on the display unit 107. Once pressing of a “yes” button 515 is detected on the screen 513 via the input interface 105, the CPU 101 stores disagree as the agreement state of the permission language (the type of permission) as the target of the current agreement acceptance processing. Once pressing of a “no” button 516 is detected on the screen 513, the CPU 101 displays the screen 508.

FIG. 6 is a flowchart illustrating processing of adding the application to the image processing apparatus 100. The present flowchart is started in a case where the CPU 101 executes application adding processing. Additionally, each processing of the present flowchart is implemented with the CPU 101 deploying the program of the application stored in the program memory 102 in the RAM 110 to execute. Note that, “S” in description of each processing below means a step in the flowchart.

In S601, the CPU 101 obtains a list of the applications from the application provision server 005 and displays the list on the display unit 107. In S602, the CPU 101 determines whether pressing of an add button is detected from the list of the additional applications. If it is determined that the add button is detected, the CPU IOI proceeds to S603. If it is determined that the add button is not detected, the CPU 101 continues displaying the list of the additional applications.

In S603, the CPU 101 executes install processing of the additional application. That is, the application corresponding to the pressed add button is obtained from the application provision server 005 and stored in the program memory 102. In S604, the CPU 101 determines whether the storing of the application in the program memory 102 succeeds. If it is determined that the storing succeeds, the CPU 101 proceeds to S605. If it is determined that the storing fails, the CPU 101 displays a notification about the storing fails on the display unit 107 and ends the processing of the present flowchart.

In S605, the CPU 101 registers “application name,” “information indicating whether permission is necessary or unnecessary,” “type of permission,” and “account information” of the application that is added this time to the management information of the application group illustrated in FIG. 3. In S606, the CPU 101 sets “state of whether it is first launching or not” to “yes” in the application added this time. Thereafter, the CPU 101 ends the processing of the present flowchart.

FIG. 7 is a flowchart illustrating a control method of the application of the image processing apparatus 100 in the present example. Each processing in the present flowchart is implemented with the CPU 101 deploying the program stored in the program memory 102 in the RAM 110 to execute. Additionally, the present flowchart is started in a case where the CPU 101 launches the application.

In S700, the CPU 101 determines whether there is an instruction to launch (an operation to execute a function of the application) any one of the multiple pieces of the application software (hereinafter, simply referred to as applications). If it is determined that there is the instruction to launch, the CPU 101 proceeds to S701, and if not, the CPU 101 waits for the instruction to launch any one of the applications in S700.

In S701, the CPU 101 determines whether the launched application is the application that needs the permission with reference to the management information of the application group illustrated in FIG. 3. If it is determined that the permission is unnecessary, the CPU 101 proceeds to S714, and if it is determined that the permission is necessary, the CPU 101 proceeds to S702.

In S702, the CPU 101 determines whether the launched application is the application that needs the permission A. The present processing is executed with the CPU 101 referring to the management information of the application group of the non-volatile memory 109 (FIG. 3). If it is determined that it is the application that needs the permission A, the CPU 101 proceeds to S703. If it is determined that it is the application that does not need the permission A, the CPU 101 proceeds to S707.

In S703, the CPU 101 determines whether the launched application already agrees with the permission A. The present processing is executed with the CPU 101 referring to the agreement state of the permission A of the non-volatile memory 109 (FIG. 4). If it is determined that the application already agrees with the permission A, the CPU 101 proceeds to S707. If it is determined that the application does not agree with the permission A yet, the CPU 101 proceeds to S704.

In S704, the CPU 101 determines whether the launched application is the application that is launched for the first time (the first launching). The present processing is executed with reference to the management information of the application group of the non-volatile memory 109 (FIG. 3). If it is determined that it is the first launching, the CPU 101 proceeds to S706. If it is determined that it is not the first launching (second and subsequent launching), the CPU 101 proceeds to S705.

In S705, the CPU 101 determines whether disagree is stored with reference to the agreement state (the permission state) of the permission A stored in the non-volatile memory 109 illustrated in FIG. 4. If it is determined that disagree is stored for the permission A (already disagree), the CPU 101 proceeds to S707, and if it is determined that disagree is not stored for the permission A (do not disagree yet), the CPU 101 proceeds to S706. Note that, a case of determining that the permission is not agreed yet in S703 and determining that the permission is not disagreed yet in S705 is a case where “do not agree yet” is set for the permission A, for example.

In S706, the CPU 101 displays the agreement acceptance screen of the permission A and performs the agreement acceptance processing on the permission A. The agreement acceptance processing is the processing described with reference to the screen transition diagram illustrated in FIG. 5. First, the CPU 101 displays the screen 500 as a permission acceptance screen of the permission A in FIG. 5 and performs the processing described above in FIG. 5 according to the operation by the user. In a case where the user presses the agree button 510, the CPU 101 stores “agree” as the agreement state of the permission A of the non-volatile memory illustrated in FIG. 4 and stores the permission version associated with the permission language as the permission version. On the other hand, in a case where the user presses the disagree button 511, the CPU 101 stores “disagree” as the agreement state of the permission A illustrated in FIG. 4.

Here, for example, a case where the CPU 101 launches the additional application C for the first time is assumed. It can be seen with reference to the type of permission in the management information in FIG. 3 that the additional application C is the application that needs the permission A. Additionally, it can be seen with reference to the agreement state illustrated in FIG. 4 that the permission A is “disagree,” which is a notification indicating that the disagreement with the permission A is stored by the user. In general, in a case where the user already disagrees with the permission A, the CPU 101 does not perform the agreement acceptance processing on the permission A in a case of launching the additional application C. However, in the present embodiment, the CPU 101 executes the agreement acceptance processing on the permission A on the condition that the additional application C is launched for the first time.

Note that, as described above, for example, in a case where the agreement state of the permission A is stored as “agree” even in a case where the additional application C is launched for the first time, the CPU 101 does not display the agreement acceptance screen for the permission A (does not execute the agreement acceptance processing). This is because it is confirmed in S703 that the agreement with the permission A necessary to utilize the application C is already obtained before it is determined whether the application C is launched for the first time. Additionally, for example, also in a case where the agreement state of the permission A necessary to utilize the application C is stored as “disagree,” the agreement acceptance processing on the permission A is not executed in a case where the application C is launched for the second and subsequent time. The reason of not performing the agreement acceptance processing for the second and subsequent time also in a case where disagree is stored is that there is a possibility of losing the convenience for the user by displaying the agreement acceptance screen again even though the operation indicating the disagreement for the utilization of the application C is performed once.

In S707, the CPU 101 determines whether the launched application is the application that needs the permission B. The present processing is executed with the CPU 101 referring to the management information of the application group of the non-volatile memory 109 (FIG. 3). If it is determined that it is the application that needs the permission B, the CPU 101 proceeds to S708. If it is determined that it is the application that does not need the permission B, the CPU 101 proceeds to S712.

In S708, the CPU 101 determines whether the launched application already agrees with the permission B. The present processing is executed with the CPU 101 referring to the agreement state of the permission B of the non-volatile memory 109 (FIG. 4). If it is determined that the application already agrees with the permission B, the CPU 101 proceeds to S712. If it is determined that the application does not already agree with the permission B, the CPU 101 proceeds to S709.

In S709, the CPU 101 determines whether the launched application is the application that is launched for the first time (the first launching). The present processing is executed with reference to the management information of the application group of the non-volatile memory 109 (FIG. 3). If it is determined that it is the first launching, the CPU 101 proceeds to S711. If it is determined that it is not the first launching (the second and subsequent launching), the CPU 101 proceeds to S710.

In S710, the CPU 101 determines whether disagree is stored with reference to the agreement state (the permission state) related to the permission B stored in the non-volatile memory 109 illustrated in FIG. 4. If it is determined that disagree is stored for the permission B (already disagree), the CPU 101 proceeds to S712, and if it is determined that disagree is not stored for the permission B (do not disagree yet), the CPU 101 proceeds to S711. In S711, the CPU 101 displays the agreement acceptance screen of the permission B and performs the agreement acceptance processing on the permission B.

In S712, the CPU 101 sets the state of the launched application indicating whether it is launched for the first time or not as “no.” This is executed with the CPU 101 referring to the management information of the application group of the non-volatile memory 109 (FIG. 3).

In S713, the CPU 101 determines whether the types of permissions that are necessary for the launched application are all agreed with reference to the management information of the application group (FIG. 3) and the agreement state (FIG. 4) of the non-volatile memory 109. If it is determined that the necessary types of permissions are all agreed, the CPU 101 proceeds to S714. If not, that is, if it is determined that at least any one of the agreement states of the types of the necessary permission languages is stored as do not agree yet, disagree, or need agreement again, the CPU 101 proceeds to S715.

In S714, the CPU 101 executes predetermined processing by the launched application, that is, the function by the launched application. For example, processing of executing the function of the launched application such as printing the image data on the cloud by the image processing apparatus 100 in cooperation with the service provision server group 001 and saving the image data scanned by the image processing apparatus 100 on the cloud. Thereafter, the CPU 101 ends the processing of the present flowchart.

In S715, the CPU 101 ends the processing of the present flowchart by stopping the processing of the application currently controlled, or without launching. In this case, the processing of the application ends without executing the function of the application instructed to launch, or without launching. Thus, the CPU 101 controls transmission of the information so as not to transmit the information to the application that does not obtain the necessary agreement. The above is the flowchart in the present embodiment.

In the present embodiment, basically, the agreement acceptance processing on the permission is performed in S706 or S711 in the first launching, and “agree” or “disagree” is determined. That is, in the present embodiment, after the application is launched, the permission related to the application is set to “agree” or “disagree.” In a case other than the first launching, Yes in S704 and Yes in S705 are obtained in a case where “disagree” is set for the necessary permission that is the permission A, for example, and the application ends in S715 without S706. That is, in a case where “disagree” is set in a case where the instruction is provided in the second and subsequent launching, the permission acceptance screen is not displayed, and it is not asked again since the operation to disagree about the corresponding application is already performed once.

Here, a case where the agreement state is “do not agree yet” is described. For example, in a case where the agreement state about the permission A is “do not agree yet,” the agreement acceptance screen illustrated in FIG. 5 is displayed in S706 in the first launching of the application C. In this case, if the processing ends without selecting agree or disagree for any reason, “do not agree yet” remains stored as the agreement state of the permission A. In a case where the application C is closed in the above-described state and is launched again, it is a state in which “the agreement state is “do not agree yet” and the application C is launched for the second and subsequent time.” In the above-described state, it is determined as “no” in S704, and it is determined as “no” also in S705. That is, the processing proceeds to S706, and the agreement acceptance processing on the permission A is executed. Thus, the agreement acceptance processing is executed (a permission agreement screen is displayed) also in the state in which “the agreement state is “do not agree yet” and the application C is launched for the second and subsequent time.”

As above, according to the present embodiment, in a case where the application software is added, it is possible to execute preferable processing to utilize the application software depending on the agreement state. Specifically, even in a case where the agreement state about the permission necessary for the additionally installed application is “disagree,” it is possible to perform control to perform the agreement acceptance processing in a case where the additionally installed application is launched for the first time. Thus, even in a case where the user disagrees with the target permission once in the already-existing application, the user can use the additional application without a bothersome operation.

### Embodiment 2

Embodiment 1 is described to be performed by the image processing apparatus 100. That is, the image processing apparatus 100 executes the processing in the flowchart in FIG. 7 with referenced to the agreement state from the own storage unit without cooperating with another device. Embodiment 2 describes a mode in which the agreement state stored in the storage unit of the image processing apparatus 100 (FIG. 4) is updated with the mobile terminal 200 accessing the permission agreement acceptance screen of the embedded WEB browser included in the image processing apparatus 100 via the communication control unit 204. That is, a mode in which a corresponding electronic device (the mobile terminal) cooperates with a second electronic device (the image processing apparatus) as the other device (an external device) to obtain the agreement state from the second electronic device, and the obtained agreement state is used to launch the application in the corresponding electronic device is described.

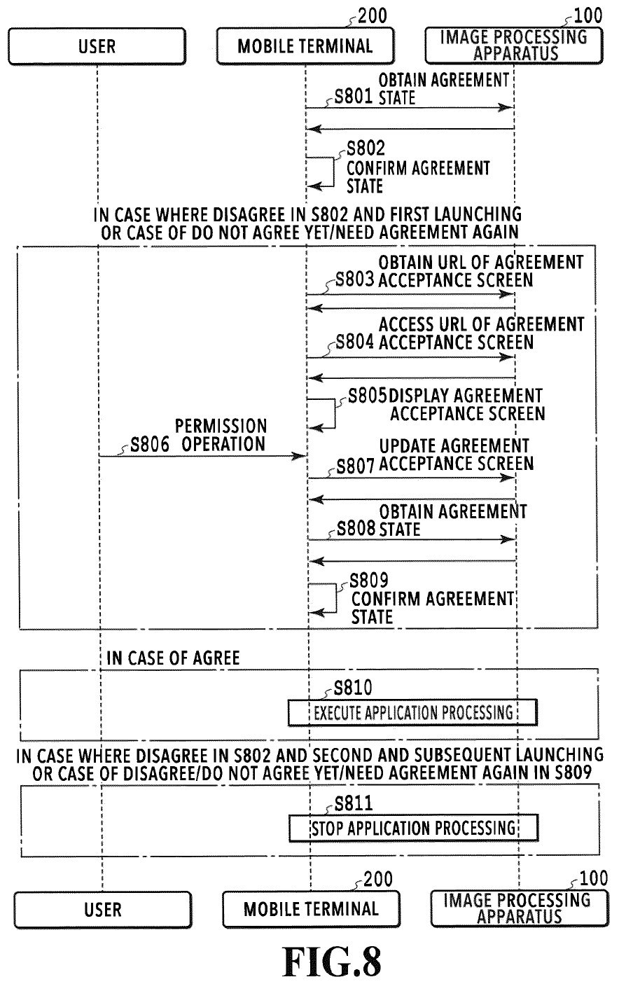

FIG. 8 is a flowchart illustrating a control method of the application of the mobile terminal 200 in the present embodiment. Each processing in the present flowchart is implemented with the CPU 201 of the mobile terminal 200 deploying the program stored in the program memory 202 in the RAM 210 to execute. The present flowchart is started in a case where the CPU 201 of the mobile terminal 200 launches the application.

In S801, the CPU 201 obtains the agreement state stored in the image processing apparatus 100 via the communication control unit 204 (FIG. 4). In S802, the CPU 201 confirms the obtained agreement state. In a case where “disagree” is stored as the agreement state of the permission necessary to utilize the corresponding application, and the corresponding application is launched for the first time in the mobile terminal 200, the CPU 201 proceeds to S803. Additionally, in a case where “do not agree yet” or “need agreement again” is stored as the agreement state of the permission necessary to utilize the corresponding application, the CPU 201 proceeds to S803. On the other hand, in a case where “agree” is stored as the agreement state of the permission necessary to utilize the corresponding application, the CPU 201 proceeds to S810. Additionally, in a case where “disagree” is stored as the agreement state of the permission necessary to utilize the corresponding application, and the corresponding application is launched for the second and subsequent time in the mobile terminal 200, the CPU 201 proceeds to S811.

In S803, the CPU 201 obtains the URL of the agreement acceptance screen of the embedded WEB browser included in the image processing apparatus 100 (FIG. 5) via the communication control unit 204. For example, the URL like “http://192.168.xx.xx/kyodaku.html” is obtained. In this process, it is also possible to designate the type of permission (FIG. 3) and obtain the URL of the agreement acceptance screen.

In S804, the CPU 201 accesses the obtained URL via the communication control unit 204. In S805, the CPU 201 displays the information obtained by accessing the URL on the display unit 207. Then, the CPU 201 waits for the user operation. In S806, the user performs the permission operation via the input interface 205 with reference to the display unit 207. In S807, the CPU 201 updates the agreement acceptance screen (FIG. 5) via the communication control unit 204. In this process, the CPU 101 of the image processing apparatus 100 stores agree or disagree in the agreement state (FIG. 4).

In S808, the CPU 201 obtains the agreement state via the communication control unit 204. In this process, the CPU 101 of the image processing apparatus 100 returns the value of the agreement state (FIG. 4) to the mobile terminal 200. In S809, the CPU 201 confirms the obtained agreement state. If the agreement state is “agree,” the CPU 201 proceeds to S810. If the agreement state is “disagree,” “do not agree yet,” or “need agreement again,” the CPU 201 proceeds to S811.

In S810, the CPU 201 executes the processing of the application currently controlled. For example, the CPU 201 performs processing of saving the image data scanned by the image processing apparatus 100 on the cloud and the like in cooperation with the image processing apparatus 100. In S811, the CPU 201 stops the processing of the application currently controlled and ends the processing of the present flowchart.

According to the present embodiment, it is possible to perform control to perform the agreement acceptance processing in a case where the application of the mobile terminal 200 is launched for the first time even in a case where the agreement state is “disagree” for the application of the image processing apparatus 100. That is, it is possible to utilize the application of the mobile terminal 200 by updating the agreement state even in a case where the agreement state is “disagree” for the application of the image processing apparatus 100.

Note that, although it is described assuming that the management information illustrated in FIG. 3 and the agreement state illustrated in FIG. 4 are stored in the non-volatile memory 109 (the storage unit) of the image processing apparatus 100 in the above-described embodiment, it is not limited thereto in reality. For example, a mode in which a server that manages the management information and the agreement state is prepared, and the agreement state operated by the image processing apparatus 100 and the mobile terminal is stored in the server may be applied. In the above-described case, the mobile terminal 200 may obtain the agreement state by communicating with the server instead of the image processing apparatus 100 in S801 in FIG. 8.

### OTHER EMBODIMENTS

Note that, the above-described various controls described to be performed by the image processing apparatus 100 may be performed by a single piece of hardware, or the overall apparatus may be controlled with multiple pieces of hardware (for example, multiple processors and circuits) sharing the processing.

Additionally, although the present disclosure is described in detail based on the preferable embodiments thereof, the present disclosure is not limited to the specific embodiments, and various modes within the scope of the gist of the disclosure are also included in the present disclosure. In addition, the above-described embodiments indicate merely an embodiment of the present disclosure, and it is also possible to combine the embodiments as needed.

Moreover, although a case where the present disclosure is applied to the image processing apparatus or the mobile terminal is described as an example in the above-described embodiments, it is not limited to this example and is also applicable to a printer apparatus including a display or an information processing apparatus.

As above, according to the present disclosure, in a case where application software is added, it is possible to execute preferable processing to utilize the application software depending on an agreement state.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to reads out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-165397, filed Sep. 24, 2024, which is hereby incorporated by reference herein in its entirety.

What is claimed is:

1. An electronic device, comprising at least one memory and at least one processor and/or at least one circuit which function as:
an obtainment unit configured to obtain information indicating an agreement state of a user about a permission content; and
a control unit configured to perform control to execute predetermined processing by application software without displaying an acceptance screen to accept an operation indicating agreement from the user in a case of a first state, in which the user agrees with all the one or more permission contents that include a first permission content and that need to obtain agreement of the user to utilize the application software in a case where first launching of the application software is instructed, and configured to perform control to display the acceptance screen before executing the predetermined processing in a case of a second state, in which the agreement state about the first permission content corresponds to disagreement of the user in a case where the first launching of the application software is instructed.

2. The electronic device according to claim 1, wherein the at least one memory and the at least one processor further function as:
a recording unit configured to perform control to record first information as the agreement state about the permission content, in a case where a first operation indicating that the user agrees with the permission content is accepted in a state in which the acceptance screen is displayed, and to record second information as the agreement state about the permission content, in a case where a second operation indicating that the user disagrees with the permission content is accepted in a state in which the acceptance screen is displayed.

3. The electronic device according to claim 2, wherein
the second state is a case where information indicating the agreement state of the user for the first permission content that is obtained by the obtainment unit is the second information.

4. The electronic device according to claim 2, wherein
the control unit performs control to execute the predetermined processing by the application software based on the acceptance of the first operation on the acceptance screen displayed in a case where the first launching of the application software is instructed.

5. The electronic device according to claim 4, wherein
the control unit performs control to end processing of the application software without performing the predetermined processing or so as not to launch the application software, in a case where the second operation is accepted on the acceptance screen displayed in a case where the first launching of the application software is instructed.

6. The electronic device according to claim 2, wherein
in a case of a state neither the first operation nor the second operation is performed on the permission content, information indicating the agreement state that is obtained by the obtainment unit is third information.

7. The electronic device according to claim 6, wherein
the control unit performs control to display the acceptance screen regardless of whether it is the first launching in a case where launching of the application software is instructed, in a case where information of the agreement state about the first permission content that is obtained by the obtainment unit is the third information.

8. The electronic device according to claim 1, wherein
the control unit performs control to end processing of the application software without displaying the acceptance screen or so as not to launch the application software, in a case where the agreement state about the first permission content is the second state in a case where second and subsequent launching of the application software is instructed.

9. The electronic device according to claim 1, wherein
the control unit performs control to execute the predetermined processing without displaying the acceptance screen, in a case where it is the first state in a case where second and subsequent launching of the application software is instructed.

10. The electronic device according to claim 1, further comprising:
a storage unit, wherein
the obtainment unit obtains information indicating the agreement state stored in the storage unit.

11. The electronic device according to claim 1, wherein
the obtainment unit obtains information indicating the agreement state from an external device different from the electronic device.

12. The electronic device according to claim 11, wherein
the control unit performs control to display the acceptance screen on the electronic device by accessing a URL of an embedded WEB browser of the external device.

13. The electronic device according to claim 1, wherein
the control unit performs control to display different languages on the acceptance screen between a case where the application software is launched for the first time and a case of launching for second and subsequent time.

14. The electronic device according to claim 1, wherein
information indicating whether the application software is launched for the first time is stored in a storage unit, and the information indicating whether the application software is launched for the first time is updated in a case where the application software is launched for the first time.

15. The electronic device according to claim 1, wherein
the application software is software configured to provide a service by communicating with a server system on the Internet.

16. A control method of an electronic device, comprising:
obtaining information indicating an agreement state of a user about a permission content; and
performing control to execute predetermined processing by application software without displaying an acceptance screen to accept an operation indicating agreement from the user in a case of a first state, in which the user agrees with all the one or more permission contents that include a first permission content and that need to obtain agreement of the user to utilize the application software in a case where first launching of the application software is instructed, and performing control to display the acceptance screen before executing the predetermined processing in a case of a second state, in which the agreement state about the first permission content corresponds to disagreement of the user in a case where the first launching of the application software is instructed.

17. A non-transitory computer readable storage medium storing a program which functions in an electronic device and causes the electronic device to function as:
an obtainment unit configured to obtain information indicating an agreement state of a user about a permission content; and
a control unit configured to perform control to execute predetermined processing by application software without displaying an acceptance screen to accept an operation indicating agreement from the user in a case of a first state, in which the user agrees with all the one or more permission contents that include a first permission content and that need to obtain agreement of the user to utilize the application software in a case where first launching of the application software is instructed, and configured to perform control to display the acceptance screen before executing the predetermined processing in a case of a second state, in which the agreement state about the first permission content corresponds to disagreement of the user in a case where the first launching of the application software is instructed.
